(19) United States
(12) Patent Application Publication
(10) Pub. No.: US 2018/0103483 A1
(43) Pub. Date: Apr. 12, 2018

(54) DATA TRANSMISSION METHOD AND APPARATUS

(71) Applicant: HUAWEI TECHNOLOGIES CO., LTD., Shenzhen (CN)

(72) Inventors: Jianqin LIU, Beijing (CN); Bingyu QU, Beijing (CN); Jian ZHANG, Shanghai (CN)

(21) Appl. No.: 15/837,816

(22) Filed: Dec. 11, 2017

Related U.S. Application Data
(63) Continuation of application No. PCT/CN2015/083013, filed on Jun. 30, 2015.

(51) Int. Cl. H04W 72/08; H04W 72/04

(52) U.S. Cl. CPC H04W 72/085; H04W 72/042; H04W 72/0453

(57) ABSTRACT

The present disclosure provides a data transmission method and apparatus. The method includes: determining S transmission subbands for a user equipment (UE), where the S transmission subbands do not overlap each other, and S is an integer greater than or equal to 2; sending a respective reference signal on each of the S transmission subbands, so that the UE selects at least two transmission subbands from M transmission subbands in the S transmission subbands based on channel quality measurements of the reference signals on the M transmission subbands, and accesses the at least two transmission subbands, where M is an integer greater than or equal to 2 and less than or equal to S; and sending a data channel signal to the UE on the at least two transmission subbands.

### CROSS-REFERENCE TO RELATED APPLICATION

This application is a continuation of International Application No. PCT/CN2015/083013, filed on Jun. 30, 2015, the disclosure of which is hereby incorporated by reference in its entirety.

### TECHNICAL FIELD

The present invention relates to the field of communications technologies, and in particular, to a data transmission method and apparatus.

### BACKGROUND

With development of intelligent terminals, the intelligent terminal can support increasingly more types of services such as a video service. Therefore, current spectrum resources cannot meet explosively growing capacity requirements of the intelligent terminal. A high frequency band with a larger available bandwidth gradually becomes a candidate frequency band of a next-generation communications system. For example, in a range of 3 GHz to 200 GHz, a potentially available bandwidth is about 250 GHz.

However, different from an operating frequency band of an existing communications system, at a same propagation distance, the high frequency band causes larger path losses. Especially, impact of factors such as the atmosphere and vegetation further increases radio propagation losses. Therefore, to compensate for a path loss caused by the high frequency band to ensure that two communications devices with a relatively long relative distance can still communicate, an optional manner is to provide a higher antenna gain for the high frequency band. In this way, an analog beam of the high frequency band is much narrower than that of a low frequency band. Each high-frequency analog narrow beam can cover only some users in a cell. Therefore, to ensure that each user in the cell can receive a signal of a common channel, all the users in the cell can be covered in a time division sending manner by using multiple analog beams. However, when movement of a user causes a change of a required analog beam, a connection has relatively poor continuity and stability.

Therefore, in the prior art, when the high frequency band is used for cellular communication, a relatively narrow high-frequency analog beam causes relatively poor data transmission reliability.

### SUMMARY

Embodiments of the present invention provide a data transmission method and apparatus, to resolve a prior-art technical problem of poor data transmission reliability caused by a relatively narrow high-frequency analog beam when a high frequency band is used for cellular communication.

According to a first aspect, the present invention provides a data transmission method, including:

determining S transmission subbands for user equipment UE, where the S transmission subbands do not overlap each other, and S is an integer greater than or equal to 2;

separately sending a reference signal on the S transmission subbands, so that the UE selects at least two transmission subbands from M transmission subbands in the S transmission subbands based on channel quality measurement of reference signals on the M transmission subbands, and separately accesses the at least two transmission subbands, where M is an integer greater than or equal to 2 and less than or equal to S; and

separately sending a data channel signal to the UE on the at least two transmission subbands.

With reference to the first aspect, in a first possible implementation of the first aspect, the determining S transmission subbands for user equipment UE includes:

determining the S transmission subbands for the UE according to predefined information, where the predefined information is cell-specific or user-specific.

With reference to the first aspect, in a second possible implementation of the first aspect,

data channel signals separately sent on the at least two transmission subbands are corresponding to a same hybrid automatic repeat request HARQ process and a same transmission mode.

With reference to the first aspect, or the first or the second possible implementation of the first aspect, in a third possible implementation of the first aspect, after the separately sending a reference signal on the S transmission subbands, the method further includes:

separately sending at least one of a reference signal, a synchronization signal, a broadcast channel BCH signal, or a control channel signal on the at least two transmission subbands.

With reference to the third possible implementation of the first aspect, in a fourth possible implementation of the first aspect, the reference signals separately sent on the at least two transmission subbands have a same configuration.

With reference to the first aspect, or the first or the second possible implementation of the first aspect, in a fifth possible implementation of the first aspect, after the separately sending a reference signal on the S transmission subbands, the method further includes:

determining a transmission subband in the at least two transmission subbands as a common transmission subband; and

simultaneously sending at least one set of signals on the common transmission subband by using at least one different analog beam, where each set of signals includes at least one signal of a reference signal, a synchronization signal, a system information block SIB, and a common search space CSS signal of a control channel.

With reference to the fifth possible implementation of the first aspect, in a sixth possible implementation of the first aspect, the method further includes:

sending instruction information on the common transmission subband, where the instruction information is used to instruct to use at least one other transmission subband in the S transmission subbands as an additional transmission subband that is used to transmit the CSS signal.

With reference to the first aspect, or the first to the sixth possible implementations of the first aspect, in a seventh possible implementation of the first aspect,

each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

With reference to the first aspect, or the first to the seventh possible implementations of the first aspect, in an eighth possible implementation of the first aspect, after the determining S transmission subbands for user equipment UE, the method further includes:

sending configuration information of the S transmission subbands to the UE, so that the UE determines the S transmission subbands according to the configuration information, where the configuration information is cell-specific or user-specific.

According to a second aspect, the present invention provides a data transmission method, including:

separately receiving, by user equipment UE, a reference signal on S transmission subbands, where the S transmission subbands do not overlap each other, and S is an integer greater than or equal to 2;

performing, by the UE, channel quality measurement on reference signals on M transmission subbands in the S transmission subbands;

selecting, by the UE, at least two transmission subbands from the M transmission subbands according to channel quality measurement results;

accessing, by the UE, the at least two transmission subbands; and

sending, by the UE, a data channel signal on the at least two transmission subbands.

With reference to the second aspect, in a first possible implementation of the second aspect, before the separately receiving, by user equipment UE, a reference signal on S transmission subbands, the method further includes:

determining the S transmission subbands according to predefined information, where the predefined information is cell-specific or user-specific; or

receiving configuration information of the S transmission subbands, and determining the S transmission subbands based on the configuration information, where the configuration information is cell-specific or user-specific.

With reference to the second aspect, in a second possible implementation of the second aspect, data channel signals sent by the UE on the at least two transmission subbands are corresponding to a same hybrid automatic repeat request HARQ process and a same transmission mode.

With reference to the second aspect, or the first or the second possible implementation of the second aspect, in a third possible implementation of the second aspect, after the accessing, by the UE, the at least two transmission subbands, the method further includes:

separately receiving, by the UE, at least one of a reference signal, a synchronization signal, a broadcast channel BCH signal, or a control channel signal on the at least two transmission subbands.

With reference to the third possible implementation of the second aspect, in a fourth possible implementation of the second aspect, reference signals separately received by the UE on the at least two transmission subbands have a same configuration.

With reference to the second aspect, or the first or the second possible implementation of the second aspect, in a fifth possible implementation of the second aspect, after the accessing, by the UE, the at least two transmission subbands, the method further includes:

simultaneously receiving, by the UE on a common transmission subband, at least one set of signals sent by using at least one different analog beam, where each set of signals includes at least one signal of a reference signal, a synchronization signal, a system information block SIB, and a common search space CSS signal of a control channel, and the common transmission subband is one of the at least two transmission subbands.

With reference to the fifth possible implementation of the second aspect, in a sixth possible implementation of the second aspect, after the accessing, by the UE, the at least two transmission subbands, the method further includes:

receiving, by the UE, instruction information on the common transmission subband, where the instruction information is used to instruct to use at least one other transmission subband in the S transmission subbands as an additional transmission subband that is used to transmit the CSS signal.

With reference to any one of the second aspect, or the first to the sixth possible implementations of the second aspect, in a seventh possible implementation of the second aspect, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

According to a third aspect, the present invention provides a downlink control information transmission method, including:

obtaining first downlink control information and second downlink control information;

at a first moment, sending the first downlink control information on a physical downlink control channel PDCCH by using first precoding; and

at the first moment, sending the second downlink control information on an enhanced physical downlink control channel EPDCCH by using second precoding, where the first precoding is different from the second precoding.

According to a fourth aspect, the present invention provides a data transmission apparatus, including:

a processing unit, configured to determine S transmission subbands for user equipment UE, where the S transmission subbands do not overlap each other, and S is an integer greater than or equal to 2; and

a sending unit, configured to: separately send a reference signal on the S transmission subbands, so that the UE selects at least two transmission subbands from M transmission subbands in the S transmission subbands based on channel quality measurement of reference signals on the M transmission subbands, and separately accesses the at least two transmission subbands, where M is an integer greater than or equal to 2 and less than or equal to S; and separately send a data channel signal to the UE on the at least two transmission subbands.

With reference to the fourth aspect, in a first possible implementation of the fourth aspect, the processing unit is configured to determine the S transmission subbands for the UE according to predefined information, where the predefined information is cell-specific or user-specific.

With reference to the fourth aspect, in a second possible implementation of the fourth aspect, data channel signals separately sent by the sending unit on the at least two transmission subbands are corresponding to a same hybrid automatic repeat request HARQ process and a same transmission mode.

With reference to the fourth aspect, or the first or the second possible implementation of the fourth aspect, in a third possible implementation of the fourth aspect, the sending unit is further configured to separately send at least one of a reference signal, a synchronization signal, a broadcast channel BCH signal, or a control channel signal on the at least two transmission subbands after separately sending the reference signal on the S transmission subbands.

With reference to the third possible implementation of the fourth aspect, in a fourth possible implementation of the fourth aspect, reference signals separately sent by the sending unit on the at least two transmission subbands have a same configuration.

With reference to the fourth aspect, or the first or the second possible implementation of the fourth aspect, in a fifth possible implementation of the fourth aspect, the processing unit is further configured to determine a transmission subband in the at least two transmission subbands as a common transmission subband after the sending unit separately sends the reference signal on the S transmission subbands; and

the sending unit is further configured to simultaneously send at least one set of signals on the common transmission subband by using at least one different analog beam, where each set of signals includes at least one signal of a reference signal, a synchronization signal, a system information block SIB, and a common search space CSS signal of a control channel.

With reference to the fifth possible implementation of the fourth aspect, in a sixth possible implementation of the fourth aspect, the sending unit is further configured to send instruction information on the common transmission subband, where the instruction information is used to instruct to use at least one other transmission subband in the S transmission subbands as an additional transmission subband that is used to transmit the CSS signal.

With reference to any one of the fourth aspect, or the first to the sixth possible implementations of the fourth aspect, in a seventh possible implementation of the fourth aspect, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

With reference to any one of the fourth aspect, or the first to the seventh possible implementations of the fourth aspect, in an eighth possible implementation of the fourth aspect, the method unit is further configured to: after the processing unit determines the S transmission subbands for the user equipment UE, send configuration information of the S transmission subbands to the UE, so that the UE determines the S transmission subbands according to the configuration information, where the configuration information is cell-specific or user-specific.

According to a fifth aspect, the present invention provides a data transmission apparatus, including:

a receiving unit, configured to separately receive a reference signal on S transmission subbands, where the S transmission subbands do not overlap each other, and S is an integer greater than or equal to 2;

a processing unit, configured to: perform channel quality measurement on reference signals on M transmission subbands in the S transmission subbands; select at least two transmission subbands from the M transmission subbands according to channel quality measurement results; and control user equipment UE to access the at least two transmission subbands; and

a sending unit, configured to send a data channel signal on the at least two transmission subbands.

With reference to the fifth aspect, in a first possible implementation of the fifth aspect, the processing unit is further configured to determine the S transmission subbands according to predefined information, where the predefined information is cell-specific or user-specific; or

the receiving unit is further configured to receive configuration information of the S transmission subbands, and the processing unit is further configured to determine the S transmission subbands based on the configuration information, where the configuration information is cell-specific or user-specific.

With reference to the fifth aspect, in a second possible implementation of the fifth aspect, data channel signals sent by the sending unit on the at least two transmission subbands are corresponding to a same hybrid automatic repeat request HARQ process and a same transmission mode.

With reference to the fifth aspect, or the first or the second possible implementation of the fifth aspect, in a third possible implementation of the fifth aspect, the receiving unit is further configured to separately receive at least one of a reference signal, a synchronization signal, a broadcast channel BCH signal, or a control channel signal on the at least two transmission subbands after the processing unit controls the UE to access the at least two transmission subbands.

With reference to the third possible implementation of the fifth aspect, in a fourth possible implementation of the fifth aspect, reference signals separately received by the receiving unit on the at least two transmission subbands have a same configuration.

With reference to the fifth aspect, or the first or the second possible implementation of the fifth aspect, in a fifth possible implementation of the fifth aspect, the receiving unit is further configured to: after the processing unit controls the UE to access the at least two transmission subbands, simultaneously receive, on a common transmission subband, at least one set of signals sent by using at least one different analog beam, where each set of signals includes at least one signal of a reference signal, a synchronization signal, a system information block SIB, and a common search space CSS signal of a control channel, and the common transmission subband is one of the at least two transmission subbands.

With reference to the fifth possible implementation of the fifth aspect, in a sixth possible implementation of the fifth aspect, the receiving unit is further configured to receive instruction information on the common transmission subband, where the instruction information is used to instruct to use at least one other transmission subband in the S transmission subbands as an additional transmission subband that is used to transmit the CSS signal.

With reference to any one of the fifth aspect, or the first to the sixth possible implementations of the fifth aspect, in a seventh possible implementation of the fifth aspect, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

According to a sixth aspect, the present invention provides a downlink control information transmission apparatus, including:

a processing unit, configured to obtain first downlink control information and second downlink control information; and

a sending unit, configured to: at a first moment, send the first downlink control information on a physical downlink control channel PDCCH by using first precoding; and at the first moment, send the second downlink control information on an enhanced physical downlink control channel EPDCCH by using second precoding, where the first precoding is different from the second precoding.

According to a seventh aspect, the present invention provides a network side device, including:

a processor, configured to determine S transmission subbands for user equipment UE, where the S transmission subbands do not overlap each other, and S is an integer greater than or equal to 2; and

a transmitter, configured to: separately send a reference signal on the S transmission subbands, so that the UE selects at least two transmission subbands from M transmission subbands in the S transmission subbands based on channel quality measurement of reference signals on the M transmission subbands, and separately accesses the at least two transmission subbands, where M is an integer greater than or equal to 2 and less than or equal to S; and separately send a data channel signal to the UE on the at least two transmission subbands.

With reference to the seventh aspect, in a first possible implementation of the seventh aspect, the processor is configured to determine the S transmission subbands for the UE according to predefined information, where the predefined information is cell-specific or user-specific.

With reference to the seventh aspect, in a second possible implementation of the seventh aspect, data channel signals separately sent by the transmitter on the at least two transmission subbands are corresponding to a same hybrid automatic repeat request HARQ process and a same transmission mode.

With reference to the seventh aspect, or the first or the second possible implementation of the seventh aspect, in a third possible implementation of the seventh aspect, the transmitter is further configured to separately send at least one of a reference signal, a synchronization signal, a broadcast channel BCH signal, or a control channel signal on the at least two transmission subbands after separately sending the reference signal on the S transmission subbands.

With reference to the third possible implementation of the seventh aspect, in a fourth possible implementation of the seventh aspect, reference signals separately sent by the transmitter on the at least two transmission subbands have a same configuration.

With reference to the seventh aspect, or the first or the second possible implementation of the seventh aspect, in a fifth possible implementation of the seventh aspect, the processor is further configured to determine a transmission subband in the at least two transmission subbands as a common transmission subband after the transmitter separately sends the reference signal on the S transmission subbands; and

the transmitter is further configured to simultaneously send at least one set of signals on the common transmission subband by using at least one different analog beam, where each set of signals includes at least one signal of a reference signal, a synchronization signal, a system information block SIB, and a common search space CSS signal of a control channel.

With reference to the fifth possible implementation of the seventh aspect, in a sixth possible implementation of the seventh aspect, the transmitter is further configured to send instruction information on the common transmission subband, where the instruction information is used to instruct to use at least one other transmission subband in the S transmission subbands as an additional transmission subband that is used to transmit the CSS signal.

With reference to any one of the seventh aspect, or the first to the sixth possible implementations of the seventh aspect, in a seventh possible implementation of the seventh aspect, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

With reference to any one of the seventh aspect, or the first to the seventh possible implementations of the seventh aspect, in an eighth possible implementation of the seventh aspect, the transmitter is further configured to: after the processor determines the S transmission subbands for the user equipment UE, send configuration information of the S transmission subbands to the UE, so that the UE determines the S transmission subbands according to the configuration information, where the configuration information is cell-specific or user-specific.

According to an eighth aspect, the present invention provides user equipment, including:

a receiver, configured to separately receive a reference signal on S transmission subbands, where the S transmission subbands do not overlap each other, and S is an integer greater than or equal to 2;

a processor, configured to: perform channel quality measurement on reference signals on M transmission subbands in the S transmission subbands; select at least two transmission subbands from the M transmission subbands according to channel quality measurement results; and control the user equipment to access the at least two transmission subbands; and

a transmitter, configured to send a data channel signal on the at least two transmission subbands.

With reference to the eighth aspect, in a first possible implementation of the eighth aspect, the processor is further configured to determine the S transmission subbands according to predefined information, where the predefined information is cell-specific or user-specific; or

the receiver is further configured to receive configuration information of the S transmission subbands, and the processor is further configured to determine the S transmission subbands based on the configuration information, where the configuration information is cell-specific or user-specific.

With reference to the eighth aspect, in a second possible implementation of the eighth aspect, data channel signals sent by the transmitter on the at least two transmission subbands are corresponding to a same hybrid automatic repeat request HARQ process and a same transmission mode.

With reference to the eighth aspect, or the first or the second possible implementation of the eighth aspect, in a third possible implementation of the eighth aspect, the receiver is further configured to separately receive at least one of a reference signal, a synchronization signal, a broadcast channel BCH signal, or a control channel signal on the at least two transmission subbands after the user equipment accesses the at least two transmission subbands.

With reference to the third possible implementation of the eighth aspect, in a fourth possible implementation of the eighth aspect, reference signals separately received by the receiver on the at least two transmission subbands have a same configuration.

With reference to the eighth aspect, or the first or the second possible implementation of the eighth aspect, in a fifth possible implementation of the eighth aspect, the receiver is further configured to: after the user equipment accesses the at least two transmission subbands, simultaneously receive, on a common transmission subband, at least one set of signals sent by using at least one different analog beam, where each set of signals includes at least one signal of a reference signal, a synchronization signal, a system information block SIB, and a common search space CSS signal of a control channel, and the common transmission subband is one of the at least two transmission subbands.

With reference to the fifth possible implementation of the eighth aspect, in a sixth possible implementation of the eighth aspect, the receiver is further configured to receive instruction information on the common transmission subband, where the instruction information is used to instruct to use at least one other transmission subband in the S transmission subbands as an additional transmission subband that is used to transmit the CSS signal.

With reference to the eighth aspect, or the first to the sixth possible implementations of the eighth aspect, in a seventh possible implementation of the eighth aspect, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

According to a ninth aspect, the present invention provides a network side device, including:

a processor, configured to obtain first downlink control information and second downlink control information; and

a transmitter, configured to: at a first moment, send the first downlink control information on a physical downlink control channel PDCCH by using first precoding; and at the first moment, send the second downlink control information on an enhanced physical downlink control channel EPDCCH by using second precoding, where the first precoding is different from the second precoding.

One or more technical solutions provided in the embodiments of the present invention have at least the following technical effects or advantages:

In the embodiments of the present invention, an entire system bandwidth is divided into multiple transmission subbands that do not overlap each other. UE accesses at least two transmission subbands. When the UE and a network device transmit a signal, the signal can be simultaneously transmitted on the at least two transmission subbands. Therefore, according to the method in the embodiments of the present invention, UE connection reliability can be enhanced. When the method is applied to a high frequency band, a bandwidth of the entire high frequency band may be divided into multiple transmission subbands that do not overlap each other, and the UE simultaneously accesses at least two transmission subbands. That is, according to the method in the embodiments of the present invention, diversity transmission of multiple connections is used, so that when high frequency coverage is limited, the UE connection reliability and data transmission reliability are improved, and a probability of a connection failure caused by movement of a user and a channel change in high frequency is reduced. Further, practicability of applying the high frequency band to cellular communication is improved.

### BRIEF DESCRIPTION OF DRAWINGS

FIG. 1 is a flowchart of a data transmission method according to an embodiment of the present invention;

FIG. 2 is a flowchart of another data transmission method according to an embodiment of the present invention;

FIG. 3 is a flowchart of a downlink control information transmission method according to an embodiment of the present invention;

FIG. 4 is a function block diagram of a data transmission apparatus according to an embodiment of the present invention;

FIG. 5 is a function block diagram of another data transmission apparatus according to an embodiment of the present invention;

FIG. 6 is a function block diagram of a downlink control information transmission apparatus according to an embodiment of the present invention;

FIG. 7 is a structural block diagram of a network side device according to an embodiment of the present invention;

FIG. 8 is a structural block diagram of user equipment according to an embodiment of the present invention; and

FIG. 9 is a structural block diagram of another network side device according to an embodiment of the present invention.

### DESCRIPTION OF EMBODIMENTS

Embodiments of the present invention provide a data transmission method and apparatus, so as to resolve a prior-art technical problem that reliability is relatively poor because a beam is relatively narrow when a high frequency band is used for cellular communication.

To resolve the foregoing technical problem, a main idea of a technical solution in the embodiments of the present invention is as follows:

An entire system bandwidth is divided into multiple transmission subbands that do not overlap each other, and UE accesses at least two transmission subbands. That is, at least two connections between the UE and a network side device are kept, to improve data transmission reliability.

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

In addition, the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

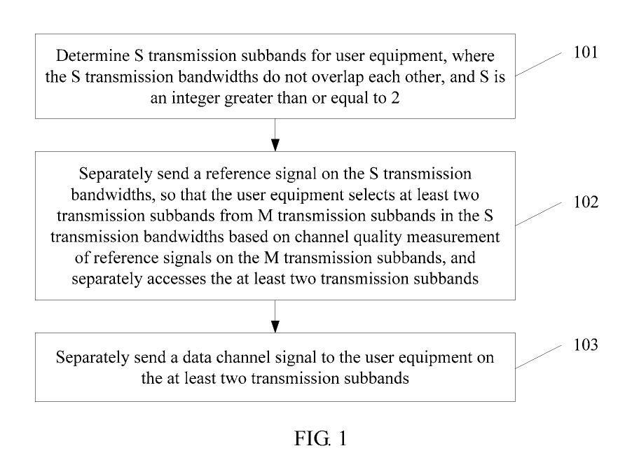

Referring to FIG. 1, FIG. 1 is a flowchart of a data transmission method according to an embodiment of the present invention. In this embodiment, the method shown in FIG. 1 is applied to a network side device. For example, the network side device is a base station. In this specification, the base station may be a device that is in an access network and that communicates with a wireless terminal over an air interface by using one or more sectors. The base station may be configured to mutually convert a received over-the-air frame and an Internet Protocol (IP) packet and serve as a router between the wireless terminal and a remaining portion of the access network. The remaining portion of the access network may include an IP network. The base station may further coordinate attribute management of the air interface. For example, the base station may be a base transceiver station (English: Base Transceiver Station, BTS for short) in Global system for mobile communications (English: Global System of Mobile communication, GSM for short) or Code Division Multiple Access (English: Code Division Multiple Access, CDMA for short), or may be a NodeB (English: NodeB, NB for short) in Wideband Code Division Multiple Access (English: Wideband Code Division Multiple Access, WCDMA for short), or may be an evolved NodeB (English: Evolutional Node B, eNB or eNodeB for short) in Long Term Evolution (English: Long Term Evolution, LTE for short), a relay node or an access point, a base station in a future 5G network, or the like. This is not limited in the present invention.

As shown in FIG. 1, the method includes the following steps:

Step 101: Determine S transmission subbands for user equipment, where the S transmission subbands do not overlap each other, and S is an integer greater than or equal to 2.

Step 102: Separately send a reference signal on the S transmission subbands, so that the user equipment selects at least two transmission subbands from M transmission subbands in the S transmission subbands based on channel quality measurement of reference signals on the M transmission subbands, and separately accesses the at least two transmission subbands, where M is an integer greater than or equal to 2 and less than or equal to S.

Step 103: Separately send a data channel signal to the user equipment on the at least two transmission subbands.

The user equipment in this specification may be a wireless terminal or may be a wired terminal. The wireless terminal may be a device that provides voice and/or other service data connectivity for a user, a handheld device with a wireless connection function, or another processing device connected to a wireless modem. The wireless terminal may communicate with one or more core networks by using a radio access network (English: Radio Access Network, RAN for short). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, the wireless terminal may be a device such as a personal communications service (English: Personal Communication Service, PCS for short) phone, a cordless telephone set, a Session Initiation Protocol (English: Session Initiation Protocol, SIP for short) phone, a wireless local loop (English: Wireless Local Loop, WLL for short) station, or a personal digital assistant (English: Personal Digital Assistant, PDA for short). The wireless terminal may also be referred to as a system, a subscriber unit (Subscriber Unit), a subscriber station (Subscriber Station), a mobile station (Mobile Station), a mobile station (Mobile), a remote station (Remote Station), a remote terminal (Remote Terminal), an access terminal (Access Terminal), a user terminal (User Terminal), a user agent (User Agent), or user equipment (User Device or User Equipment).

For ease of description, the user equipment in this specification is replaced with UE in the following.

Specifically, before step 101, as agreed or preset in a protocol, a system bandwidth has been divided into N transmission subbands, and the N transmission subbands do not overlap each other. N is an integer greater than or equal to S. Bandwidths of two transmission subbands may be the same or may be different. For example, assuming that the system bandwidth is 1 GHz, the system bandwidth may be divided into five transmission subbands of 200 MHz. Certainly, the entire bandwidth may be divided into three transmission subbands of 200 MHz, one transmission subband of 300 MHz, and one transmission subband of 100 MHz.

Correspondingly, the S transmission subbands in step 101 are all or some of the N transmission subbands. Therefore, the S transmission subbands do not overlap each other, and bandwidths of the S transmission subbands may be the same or may be different.

In actual application, a possible implementation of determining the S transmission subbands for the UE is: determining the S transmission subbands for the UE according to predefined information. Specifically, the predefined information is cell-specific information or user-specific information. The “cell-specific” means that related information of a transmission subband is cell-level information, for example, a bandwidth, a quantity, and a number of the transmission subband. That is, different UEs in a same cell obtain same related information of a transmission subband. The “user-specific” means that related information of a transmission subband is user-level information, for example, a bandwidth, a quantity, and a number of the transmission subband. That is, different UEs have independent related information of a transmission subband.

Certainly, in actual application, the S transmission subbands may be determined for the UE in another manner. This is not specifically limited in the present invention.

Optionally, after step 101, the method further includes: notifying or sending configuration information of the S transmission subbands to the UE. The configuration information of the S transmission subbands is cell-specific or user-specific. Specifically, a form in which information of the S transmission subbands is sent to the UE is shown in the following Table 1.

TABLE 1

| Cell- | User- | User- | User- | User- | User- | User- |
|---|---|---|---|---|---|---|
| specific | specific | specific | specific | specific | specific | specific |
| system | transmission | transmission | transmission | transmission | transmission | transmission |
| bandwidth | subband | subband | subband | subband | subband | subband |
| configuration | configuration 0 | configuration 1 | configuration 2 | configuration 3 | configuration 4 | configuration 5 |
| 0 | 2000 | 200 | 100 | 50 | 20 | 10 |
| 1 | 1800 | 180 | 90 | 45 | 20 | 10 |
| 2 | 1600 | 160 | 80 | 40 | 20 | 10 |
| 3 | 1400 | 140 | 70 | 35 | 20 | 10 |

In Table 1, there are six user-specific bandwidth configuration options of a transmission subband in each cell-specific system bandwidth configuration. A unit of values of bandwidth configurations of the system bandwidth or the transmission subbands in Table 1 is a resource block (English: Resource Block, RB for short). In this embodiment, it is assumed that a cell-specific system bandwidth configuration determined for UE 0 is 0, and therefore a user-specific bandwidth configuration that is of a transmission subband and that is corresponding to the cell-specific system bandwidth configuration may be one of 2000 RBs, 200 RBs, 100 RBs, 50 RBs, 20 RBs, or 10 RBs. A network device sends an index value of a cell-specific system bandwidth configuration and an index value of a corresponding user-specific transmission subband configuration to the user equipment. In the example above, when an index value of the user-specific transmission subband configuration of the UE 0 is 2, the network device needs to send only an index value 0 of the cell-specific system bandwidth configuration and the index value 2 of the user-specific transmission subband configuration to the UE 0. The sent index values may be in a (0, 2) manner or in another manner. This is not limited herein.

After the S transmission subbands are determined for the UE, step 102 is performed subsequently. That is, the reference signal is separately sent on the S transmission subbands, so that the UE selects the at least two transmission subbands from the M transmission subbands in the S transmission subbands based on the channel quality measurement of the reference signals on the M transmission subbands, and separately accesses the at least two transmission subbands.

Specifically, a reference signal may be an X-type reference signal (English: X-type Reference Signal, XRS for short). The XRS may be a cell-specific reference signal (English: cell-specific Reference Signal, CRS for short) or another user-specific reference signal in a current Long Term Evolution (English: Long Term Evolution, LTE for short) system. The user-specific reference signal is, for example, a channel state information-reference signal (English: Channel State Information-Reference Signal, CSI-RS for short) or a demodulation reference signal (English: DeModulation Reference Signal, DMRS for short).

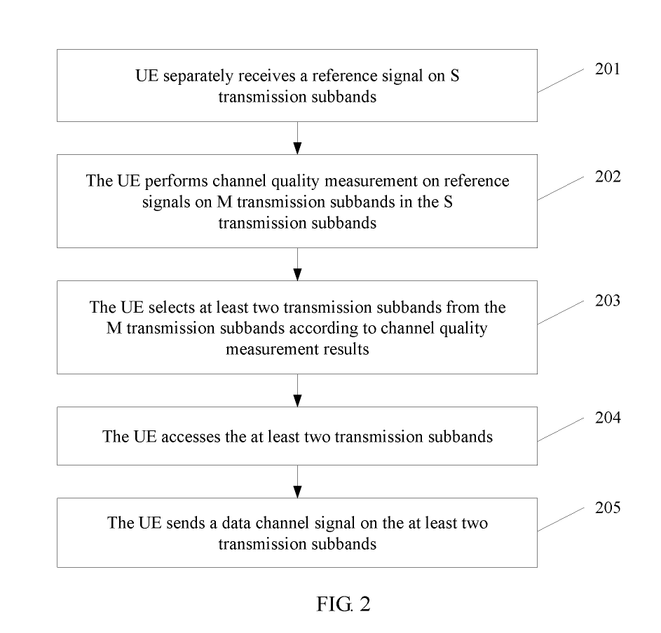

The following describes an implementation process of step 102 with reference to a data transmission method procedure on a UE side. Referring to FIG. 2, FIG. 2 is a flowchart of a data transmission method on the UE side according to an embodiment of the present invention.

As shown in FIG. 2, the method includes the following steps:

Step 201: UE separately receives a reference signal on the S transmission subbands.

Step 202: The UE performs channel quality measurement on reference signals on M transmission subbands in the S transmission subbands.

Step 203: The UE selects at least two transmission subbands from the M transmission subbands according to channel quality measurement results.

Step 204: The UE accesses the at least two transmission subbands.

Step 205: The UE sends a data channel signal on the at least two transmission subbands.

After the reference signal is sent in step 102, correspondingly, the UE performs step 201, that is, separately receives the reference signal on the S transmission subbands. It should be noted that one reference signal or one group of reference signals may be separately received on each transmission subband in the S transmission subband, and this depends on whether one reference signal or one group of reference signals are sent on each transmission subband in step 102. In short, the reference signal received in step 201 is corresponding to the reference signal sent in step 102.

Subsequently, the UE performs step 202, that is, performs the channel quality measurement on the reference signals on the M transmission subbands in the S transmission subbands. Specifically, the channel quality measurement may be radio resource management (English: Radio Resource Management, RRM for short) measurement, or may be channel quality indication (English: Channel Quality Indication, CQI for short) measurement. Certainly, in actual application, the channel quality measurement may be of another type. This is not specifically limited in the present invention.

After the channel quality measurement, step 203 is performed subsequently. That is, at least two transmission subbands are selected from the M transmission subbands according to the channel quality measurement results. In actual application, there are multiple implementations of selecting the at least two transmission subbands. For example, transmission subbands corresponding to reference signals whose channel quality measurement results rank top P may be selected, and P is a positive integer greater than or equal to 2 and less than or equal to M. Alternatively, a transmission subband corresponding to a reference signal whose channel quality measurement result is greater than a preset threshold may be selected.

It should be noted that the UE may measure reference signals on all of the S transmission subbands, and then select at least two transmission subbands according to measurement results. Alternatively, the UE may measure reference signals on some of the S transmission subbands, and then select at least two transmission subbands according to measurement results. For example, after measuring the reference signals on some of the S transmission subbands, the UE finds that a quantity of channel quality measurement results that reach the preset threshold reaches a quantity of transmission subbands that need to be accessed by the UE, and the UE may stop measurement of a reference signal on another transmission channel.

Optionally, after selecting the at least two transmission subbands, the UE may further report, to a network side device, numbers of the at least two transmission subbands or numbers of reference signals transmitted on the at least two transmission subbands.

After the at least two transmission subbands are selected, step 204 is performed subsequently. That is, the at least two transmission subbands are accessed. An access process includes: for example, separately sending, by the UE, a preamble (Preamble) sequence on the at least two transmission subbands. The network side device sends a random access response (English: Random Access Response, RAR for short) on the at least two transmission subbands. The RAR may include information such as timing and uplink resource allocation. The network side device further resolves a conflict over multiple pieces of competitive access on each transmission subband.

It should be noted that the preamble sequence sent on the at least two transmission subbands may be a preamble sequence specific to each transmission subband. That is, there are specific preamble sequences and specific physical random access channel (English: Physical Random Access Channel, PRACH for short) configuration information on different transmission subbands. The PRACH configuration information includes time density, a frequency location, an available sequence, and the like of a random access channel (English: Random Access Channel, RACH for short).

After the UE accesses the at least two transmission subbands, at least two connections between the UE and a same network side device are simultaneously kept. The network side device may perform step 103, and the UE may perform step 205. Therefore, both sending a signal by the UE to the network side device and sending a signal by the network side device to the UE are performed by using the at least two transmission subbands. Therefore, signal transmission reliability can be improved.

Optionally, in step 103 and step 205, the data channel signals separately sent on the at least two transmission subbands are corresponding to a same hybrid automatic repeat request (English: Hybrid Automatic Repeat Request, HARQ for short) process and a same transmission mode. Specifically, a data channel signal may be repeatedly mapped to the at least two transmission subbands, and in this case, data channel signals on different transmission subbands in the at least two transmission subbands are the same. In this way, it may be ensured that when an exception occurs in a data channel signal on a transmission subband, transmission on another transmission subband can still be properly performed, thereby improving data transmission reliability.

Optionally, in step 103 and step 205, the data channel signals sent on the at least two transmission subbands are each corresponding to one HARQ process. In this case, data sent on the at least two transmission subbands may be the same or may be different. Specifically, the data channel signals may be jointly mapped to the at least two transmission subbands.

Optionally, on the UE side, the UE may determine the S transmission subbands according to predefined information; or receive configuration information of the S transmission subbands, and determine the S transmission subbands according to the configuration information. The content is the same as the content described on a network device side, and is not described herein again.

Optionally, after step 101, and before, in, or after step 102, the method further includes: separately sending, on the S transmission subbands, common channel signals or common reference signals such as a broadcast channel (English: Broadcast Channel, BCH for short) signal, a primary synchronization signal (English: Primary Synchronization Signal, PSS for short), a secondary synchronization signal (English: Secondary Synchronization Signal, SSS for short), and a control channel (English: Control Channel, CCH for short) signal. Correspondingly, the UE receives the common channel signals or the common reference signals on each transmission subband, and performs time and/or frequency synchronization of each transmission subband according to the common channel signals or the common reference signals. Further, the UE may perform cell identifier (ID) identification and cyclic prefix (English: Cyclic Prefix, CP for short) length detection. Specific manners of performing the time and/or frequency synchronization, the cell ID identification, and the CP length detection are content well known by a person skilled in the art, and are not described herein.

Optionally, when an orthogonal frequency division multiplexing (English: Orthogonal Frequency Division Multiplexing, OFDM for short)-based addressing manner is used, the BCH signal, the PSS signal, and the SSS signal may occupy middle six RBs on each transmission subband, so that system overheads can be reduced.

Optionally, after step 102, the method further includes: separately sending at least one of a reference signal, a synchronization signal, a BCH signal, or a CCH signal on the at least two transmission subbands.

Specifically, the reference signal is, for example, the reference signal described above. The synchronization signal includes, for example, a PSS and an SSS.

Optionally, the reference signals separately sent on the at least two transmission subbands have a same configuration. In this embodiment, that the reference signals have a same configuration may be represented as: at least one of configuration periods, frequency density, or port information of resources of the reference signals are the same. Therefore, the user equipment may perform unified scheduling and maintenance and updating of an HARQ process based on channel quality measurement on the at least two transmission subbands. In addition, when the reference signals on the at least two transmission subbands have a same configuration, a notification of the configuration information may be simplified.

Correspondingly, the UE may receive at least one of the reference signal, the synchronization signal, the BCH signal, or the CCH signal.

When receiving the reference signal sent in this embodiment, the UE may perform RRM measurement, CQI measurement, or another channel quality measurement again. The UE reports reference signal received power (English: Reference Signal Receiving Power, RSRP for short) of the reference signals corresponding to the at least two transmission subbands. Each cell in a network is corresponding to one channel quality measurement result of the at least two transmission subbands. Optionally, the channel quality measurement result may be an average value or a maximum value of channel quality measurement results of the at least two transmission subbands. The network side device may select, based on a channel quality measurement result such as an RSRP value of each cell, an optimal target cell for the UE, and perform a subsequent hard handover between cells. However, in each cell, the UE performs a soft handover (an original connection and a new connection are simultaneously kept during a handover) between multiple transmission subbands.

A measurement and handover event between transmission subbands in each cell may be defined as: when an RSRP value of a reference signal is greater than or equal to a first threshold value, a transmission subband corresponding to the reference signal is accessed, and when an RSRP value of a reference signal is less than or equal to a second threshold value, a transmission subband corresponding to the reference signal is disconnected. Optionally, a specific handover method includes: when the user equipment is handed over from a transmission subband 1 to a transmission subband 2, the user equipment simultaneously keeps connections on two transmission subbands until the user equipment is completely handed over to the transmission subband 2.

Optionally, after step 102, the method further includes: determining a transmission subband in the at least two transmission subbands as a common transmission subband; simultaneously sending at least one set of signals on the common transmission subband. Each set of signals includes at least one signal of a reference signal, a synchronization signal, a BCH signal, a system information block (English: System Information Block, SIB for short), or a CCH signal including a common search space (CSS) signal of a CCH.

Specifically, the reference signal may be the same as the reference signal described above. The synchronization signal may include a PSS and an SSS.

Specifically, the simultaneously sending at least one set of signals on the common transmission subband may be specifically simultaneously sending the at least one set of reference signals by using at least one different analog beam, that is, in a space division sending manner. Each set of reference signals in the at least one set of reference signals is corresponding to one analog beam. Therefore, multiple sets of reference signals may be simultaneously transmitted on a same time-frequency resource. Compared with a solution of separately transmitting the at least one set of reference signals on multiple transmission subbands, resource overheads of the reference signals may be reduced.

Optionally, the common transmission subband may be designated as a primary transmission subband of all UEs. Certainly, the common transmission subband may be used as a secondary transmission subband of UE. Alternatively, the common transmission subband may be used when all the UEs need to be synchronized or periodically read system information.

Optionally, a CRS may be transmitted only on the common transmission subband, or may be sent on each transmission subband so that the UE performs fine synchronization.

Optionally, for the BCH signal, at least one of system key information such as a downlink system bandwidth, a number of a transmission subband, a bandwidth of a transmission subband, a physical HARQ indicator channel (English: Physical Hybrid ARQ Indicator Channel, PHICH for short) resource, or a system frame number (English: System Frame Number, SFN for short) is sent on each transmission subband. However, system information with relatively large overheads, for example, the SIB such as an SIB 1 to an SIB 13, is sent on the common subbandwidth. Specifically, the SIB may be transmitted on middle six physical resource blocks (PRB) on the common transmission subband, so that overheads of system design can be reduced.

Specifically, the CSS signal of a CCH is specifically, for example, a CSS signal of a physical downlink control channel (English: Physical Downlink Control Channel, PDCCH for short).

Optionally, the method further includes: sending instruction information on the common transmission subband. The instruction information is used to instruct to use at least one other transmission subband in the S transmission subbands as an additional transmission subband that is used to transmit the CSS signal. Correspondingly, the UE receives the instruction information. Usually, when a large quantity of UEs need to access the common transmission subband temporarily, an additional transmission subband may be added to transmit the CSS signal, so that a large quantity of accessed UEs receive the RAR.

Optionally, in actual application, each of the at least two transmission subbands is associated with one piece of precoding. The precoding associated with each transmission subband is precoding in a first precoding group at a first moment. The precoding associated with each transmission subband is precoding in a second precoding group at a second moment. Precoding in the first precoding group is not identical to precoding in the second precoding group. Specifically, although each transmission subband is associated with one piece of precoding, as time changes, the precoding associated with each transmission subband may change. That is, at a same moment, each transmission subband is associated with only one piece of precoding.

Specifically, each precoding group may include only one piece of precoding. In this case, at a same moment, all transmission subbands are associated with same precoding. Because all the transmission subbands are associated with same precoding, to implement wide coverage of all users in a cell, signals may be sent on each transmission subband in a time division manner, and each transmission subband is associated with different precoding at different sending moments. For example, each transmission subband is associated with precoding 1 at a moment 1, and each transmission subband is associated with precoding 2 and precoding 3 respectively at a following moment 2 and a following moment 3. Because the UE may keep connections on at least two transmission subbands at each moment, signal transmission reliability can also be improved.

Specifically, usually, when each cell supports a relatively large quantity of pieces of precoding, each precoding group may include at least two pieces of precoding. Then time division sending is performed per precoding group. Specifically, for example, each transmission subband is associated with one piece of precoding in a precoding group 1 at the moment 1, and each transmission subband is associated with one piece of precoding in a precoding group 2 at the later moment 2, and so on. Precoding in the first precoding group may overlap precoding in the second precoding group. That is, the first precoding group and the second precoding group may have a same precoding subset. Likewise, the UE may keep connections on at least two transmission subbands at each moment, and therefore signal transmission reliability can also be improved.

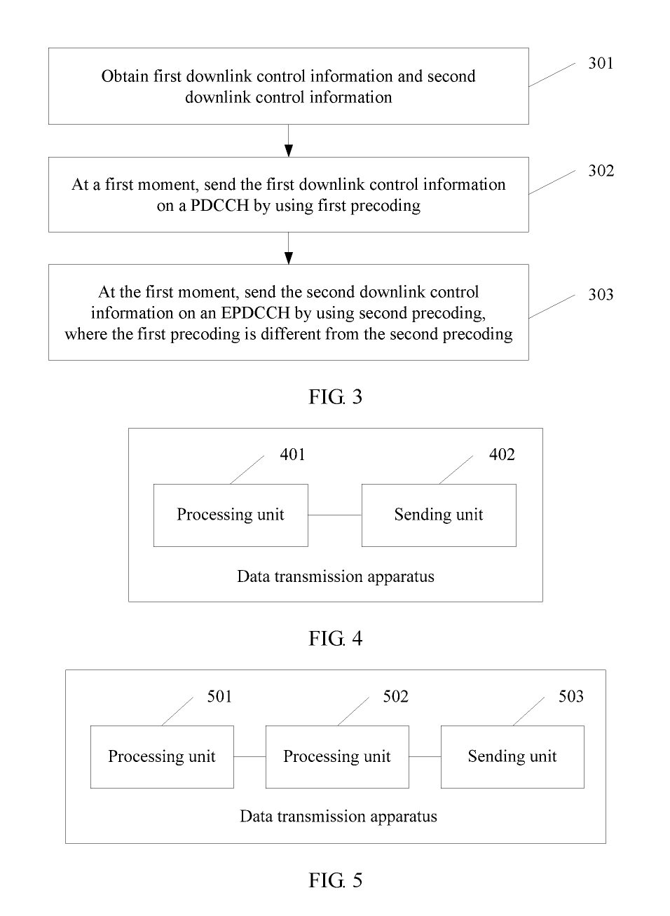

Based on a same invention concept, to enhance transmission reliability of a common channel such as a control channel, a channel diversity method may be used. Specifically, referring to FIG. 3, FIG. 3 is a flowchart of a downlink control information transmission method according to an embodiment of the present invention. The method includes the following steps:

Step 301: Obtain first downlink control information and second downlink control information.

Step 302: At a first moment, send downlink control information on a PDCCH by using first precoding.

Step 303: At the first moment, send the downlink control information on an enhanced physical downlink control channel (English: Enhanced Physical Downlink Control Channel, EPDCCH for short) by using second precoding.

Optionally, the first precoding is corresponding to a first analog beam, and the second precoding is corresponding to a second analog beam. Alternatively, the first precoding is a first analog beam, and the second precoding is a second analog beam. The first precoding is different from the second precoding, or the first analog beam is different from the second analog beam. The first downlink control information sent on the PDCCH and the second downlink control information sent on the EPDCCH may be the same or different. When the two pieces of control information are the same, according to the method in this embodiment, control information with same content is simultaneously transmitted on two control channels, to improve reliability of control information.

Optionally, a network side device such as a base station may trigger, by using higher layer signaling, implementation of the method shown in FIG. 3.

Optionally, a network side device such as a base station may indicate, on a PCFICH, whether diversity transmission of two control channels is supported currently.

Based on a same invention concept, an embodiment of the present invention further provides a data transmission apparatus to implement the method shown in FIG. 1. As shown in FIG. 4, the data transmission apparatus includes: a processing unit 401, configured to determine S transmission subbands for user equipment UE, where the S transmission subbands do not overlap each other, and S is an integer greater than or equal to 2; and a sending unit 402, configured to: separately send a reference signal on the S transmission subbands, so that the UE selects at least two transmission subbands from M transmission subbands in the S transmission subbands based on channel quality measurement of reference signals on the M transmission subbands, and separately accesses the at least two transmission subbands, where M is an integer greater than or equal to 2 and less than or equal to S; and separately send a data channel signal to the UE on the at least two transmission subbands.

Optionally, the processing unit 401 is configured to determine the S transmission subbands for the UE according to predefined information, where the predefined information is cell-specific or user-specific.

Optionally, data channel signals separately sent by the sending unit 402 on the at least two transmission subbands are corresponding to a same hybrid automatic repeat request HARQ process and a same transmission mode.

Optionally, the sending unit 402 is further configured to separately send at least one of a reference signal, a synchronization signal, a broadcast channel BCH signal, or a control channel signal on the at least two transmission subbands after separately sending the reference signal on the S transmission subbands.

Optionally, reference signals separately sent by the sending unit 402 on the at least two transmission subbands have a same configuration.

Optionally, the processing unit 401 is further configured to determine a transmission subband in the at least two transmission subbands as a common transmission subband after the sending unit 402 separately sends the reference signal on the S transmission subbands; and

the sending unit 402 is further configured to simultaneously send at least one set of signals on the common transmission subband by using at least one different analog beam, where each set of signals includes at least one signal of a reference signal, a synchronization signal, a system information block SIB, and a common search space CSS signal of a control channel.

Optionally, the sending unit 402 is further configured to send instruction information on the common transmission subband, where the instruction information is used to instruct to use at least one other transmission subband in the S transmission subbands as an additional transmission subband that is used to transmit the CSS signal.

Optionally, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

Optionally, the method unit is further configured to: after the processing unit 401 determines the S transmission subbands for the user equipment UE, send configuration information of the S transmission subbands to the UE, so that the UE determines the S transmission subbands according to the configuration information, where the configuration information is cell-specific or user-specific.

Various variations and specific instances in the data transmission method in the foregoing embodiment shown in FIG. 1 are also applicable to the data transmission apparatus in this embodiment. With the foregoing detailed descriptions of the data transmission method, a person skilled in the art can clearly understand an implementation of the data transmission apparatus in this embodiment. Therefore, for conciseness of the specification, details are not described herein again.

Based on a same invention concept, an embodiment of the present invention further provides a data transmission apparatus to implement the method shown in FIG. 2. As shown in FIG. 5, the data transmission apparatus includes: a receiving unit 501, configured to separately receive a reference signal on S transmission subbands, where the S transmission subbands do not overlap each other, and S is an integer greater than or equal to 2; a processing unit 502, configured to: perform channel quality measurement on reference signals on M transmission subbands in the S transmission subbands; select at least two transmission subbands from the M transmission subbands according to channel quality measurement results; and control user equipment UE to access the at least two transmission subbands; and a sending unit 503, configured to send a data channel signal on the at least two transmission subbands.

Optionally, the processing unit 502 is further configured to determine the S transmission subbands according to predefined information, where the predefined information is cell-specific or user-specific; or

the receiving unit 501 is further configured to receive configuration information of the S transmission subbands, and the processing unit 502 is further configured to determine the S transmission subbands based on the configuration information, where the configuration information is cell-specific or user-specific.

Optionally, data channel signals sent by the sending unit 503 on the at least two transmission subbands are corresponding to a same hybrid automatic repeat request HARQ process and a same transmission mode.

Optionally, the receiving unit 501 is further configured to separately receive at least one of a reference signal, a synchronization signal, a broadcast channel BCH signal, or a control channel signal on the at least two transmission subbands after the processing unit 502 controls the UE to access the at least two transmission subbands.

Optionally, reference signals separately received by the receiving unit 501 on the at least two transmission subbands have a same configuration.

Optionally, the receiving unit 501 is further configured to: after the processing unit 502 controls the UE to access the at least two transmission subbands, simultaneously receive, on a common transmission subband, at least one set of signals sent by using at least one different analog beam, where each set of signals includes at least one signal of a reference signal, a synchronization signal, a system information block SIB, and a common search space CSS signal of a control channel, and the common transmission subband is one of the at least two transmission subbands.

Optionally, the receiving unit 501 is further configured to receive instruction information on the common transmission subband, where the instruction information is used to instruct to use at least one other transmission subband in the S transmission subbands as an additional transmission subband that is used to transmit the CSS signal.

Optionally, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

Various variations and specific instances in the data transmission method in the foregoing embodiment shown in FIG. 2 are also applicable to the data transmission apparatus in this embodiment. With the foregoing detailed descriptions of the data transmission method, a person skilled in the art can clearly understand an implementation of the data transmission apparatus in this embodiment. Therefore, for conciseness of the specification, details are not described herein again.

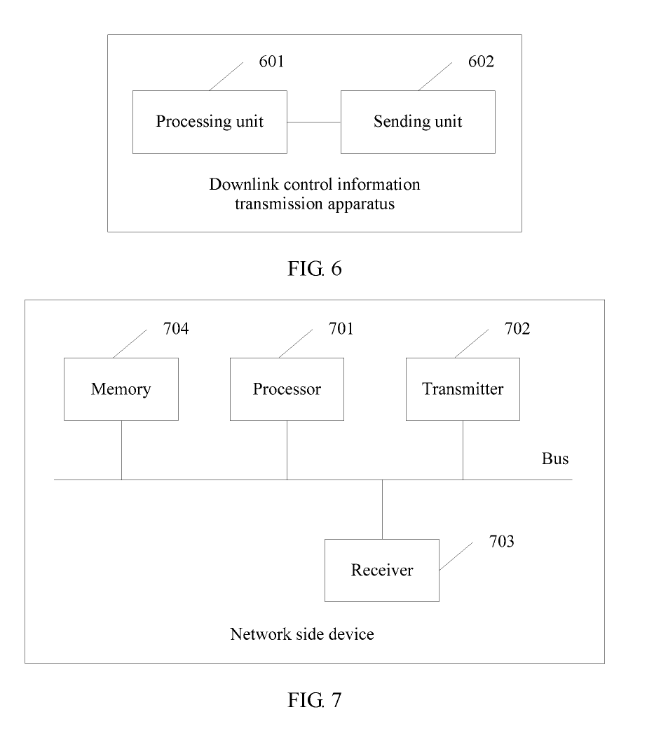

Based on a same invention concept, an embodiment of the present invention further provides a downlink control information transmission apparatus to implement the method shown in FIG. 3. As shown in FIG. 6, the downlink control information transmission apparatus includes: a processing unit 601, configured to obtain first downlink control information and second downlink control information; and a sending unit 602, configured to: at a first moment, send the first downlink control information on a physical downlink control channel PDCCH by using first precoding; and at the first moment, send the second downlink control information on an enhanced physical downlink control channel EPDCCH by using second precoding, where the first precoding is different from the second precoding.

Various variations and specific instances in the downlink control information transmission method in the foregoing embodiment shown in FIG. 3 are also applicable to the data transmission apparatus in this embodiment. With the foregoing detailed descriptions of the downlink control information transmission method, a person skilled in the art can clearly understand an implementation of the data transmission apparatus in this embodiment. Therefore, for conciseness of the specification, details are not described herein again.

Based on a same invention concept, an embodiment of the present invention further provides a network side device to implement the method shown in FIG. 1. As shown in FIG. 7, the network side device includes a processor 701, a transmitter 702, a receiver 703, and a memory 704. The processor 701 may be specifically a central processing unit or an application-specific integrated circuit (English: Application Specific Integrated Circuit, ASIC for short), or may be one or more integrated circuits used to control program execution, or may be a hardware circuit developed by using a field programmable gate array (English: Field Programmable Gate Array, FPGA for short). There may be one or more memories 704. The memory 704 may include a read-only memory (English: Read Only Memory, ROM for short), a random access memory (English: Random Access Memory, RAM for short), and a magnetic disk storage. These memories, the receiver 703, and the transmitter 702 are connected to the processing circuit 701 by using a bus. The receiver 703 and the transmitter 702 are configured to communicate with an external device by using a network, and specifically, may communicate with the external device by using a network such as the Ethernet, a radio access network, or a wireless local area network. The receiver 703 and the transmitter 702 may be two physically independent elements, or may be a physically same element.

Specifically, the processor 701 is configured to determine S transmission subbands for user equipment UE, where the S transmission subbands do not overlap each other, and S is an integer greater than or equal to 2. The transmitter 702 is configured to: separately send a reference signal on the S transmission subbands, so that the UE selects at least two transmission subbands from M transmission subbands in the S transmission subbands based on channel quality measurement of reference signals on the M transmission subbands, and separately accesses the at least two transmission subbands, where M is an integer greater than or equal to 2 and less than or equal to S; and separately send a data channel signal to the UE on the at least two transmission subbands.

Optionally, the processor 701 is configured to determine the S transmission subbands for the UE according to predefined information, where the predefined information is cell-specific or user-specific.

Optionally, data channel signals separately sent by the transmitter 702 on the at least two transmission subbands are corresponding to a same hybrid automatic repeat request HARQ process and a same transmission mode.

Optionally, the transmitter 702 is further configured to separately send at least one of a reference signal, a synchronization signal, a broadcast channel BCH signal, or a control channel signal on the at least two transmission subbands after separately sending the reference signal on the S transmission subbands.

Optionally, reference signals separately sent by the transmitter 702 on the at least two transmission subbands have a same configuration.

Optionally, the processor 701 is further configured to determine a transmission subband in the at least two transmission subbands as a common transmission subband after the transmitter 702 separately sends the reference signal on the S transmission subbands; and

the transmitter 702 is further configured to simultaneously send at least one set of signals on the common transmission subband by using at least one different analog beam, where each set of signals includes at least one signal of a reference signal, a synchronization signal, a system information block SIB, and a common search space CSS signal of a control channel.

Optionally, the transmitter 702 is further configured to send instruction information on the common transmission subband, where the instruction information is used to instruct to use at least one other transmission subband in the S transmission subbands as an additional transmission subband that is used to transmit the CSS signal.

Optionally, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

Optionally, the transmitter 702 is further configured to: after the processor 701 determines the S transmission subbands for the user equipment UE, send configuration information of the S transmission subbands to the UE, so that the UE determines the S transmission subbands according to the configuration information, where the configuration information is cell-specific or user-specific.

Various variations and specific instances in the data transmission method in the foregoing embodiment shown in FIG. 1 are also applicable to the network side device in this embodiment. With the foregoing detailed descriptions of the data transmission method, a person skilled in the art can clearly understand an implementation of the network side device in this embodiment. Therefore, for conciseness of the specification, details are not described herein again.

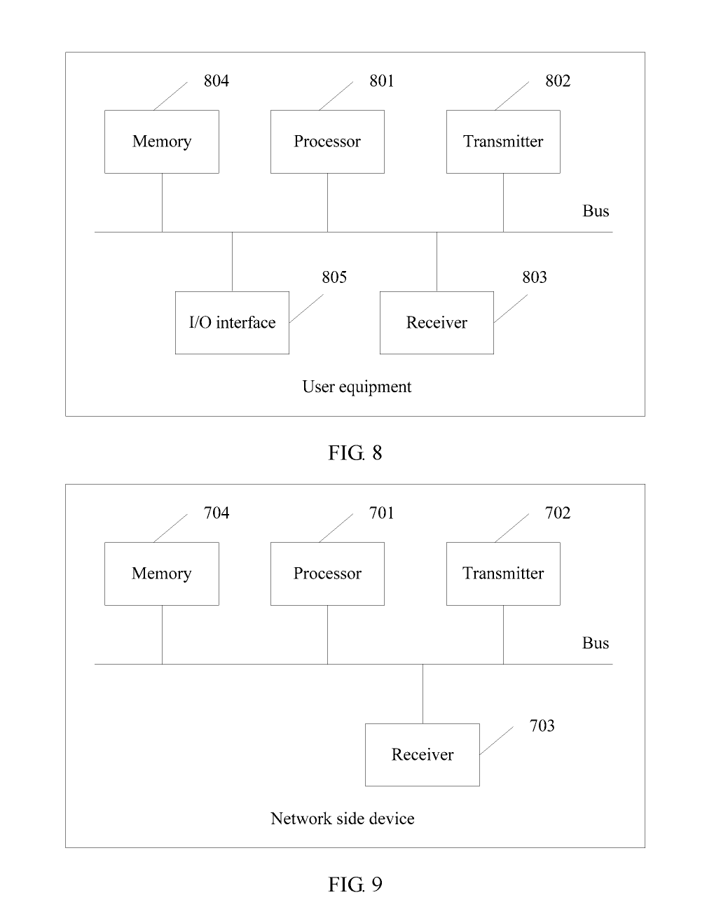

Based on a same invention concept, an embodiment of the present invention further provides user equipment to implement the method shown in FIG. 2. As shown in FIG. 8, the user equipment includes a processor 801, a transmitter 802, a receiver 803, a memory 804, and an I/O interface 805. The processor 801 may be specifically a central processing unit or an application-specific integrated circuit (English: Application Specific Integrated Circuit, ASIC for short), or may be one or more integrated circuits used to control program execution, or may be a hardware circuit developed by using a field programmable gate array (English: Field Programmable Gate Array, FPGA for short). There may be one or more memories 804. The memory 804 may include a read-only memory (English: Read Only Memory, ROM for short), a random access memory (English: Random Access Memory, RAM for short), and a magnetic disk storage. These memories, the receiver 803, and the transmitter 802 are connected to the processing circuit 801 by using a bus. The receiver 803 and the transmitter 802 are configured to communicate with an external device by using a network, and specifically, may communicate with the external device by using a network such as the Ethernet, a radio access network, or a wireless local area network. The receiver 803 and the transmitter 802 may be two physically independent elements, or may be a physically same element. The I/O interface 805 may be connected to a peripheral such as a mouse or a keyboard.

Specifically, the receiver 803 is configured to separately receive a reference signal on S transmission subbands, where the S transmission subbands do not overlap each other, and S is an integer greater than or equal to 2. The processor 801 is configured to: perform channel quality measurement on reference signals on M transmission subbands in the S transmission subbands; select at least two transmission subbands from the M transmission subbands according to channel quality measurement results; and control the user equipment to access the at least two transmission subbands. The transmitter 802 is configured to send a data channel signal on the at least two transmission subbands.

Optionally, the processor 801 is further configured to determine the S transmission subbands according to predefined information, where the predefined information is cell-specific or user-specific; or

the receiver 803 is further configured to receive configuration information of the S transmission subbands, and the processor 801 is further configured to determine the S transmission subbands based on the configuration information, where the configuration information is cell-specific or user-specific.

Optionally, data channel signals sent by the transmitter 802 on the at least two transmission subbands are corresponding to a same hybrid automatic repeat request HARQ process and a same transmission mode.

Optionally, the receiver 803 is further configured to separately receive at least one of a reference signal, a synchronization signal, a broadcast channel BCH signal, or a control channel signal on the at least two transmission subbands after the user equipment accesses the at least two transmission subbands.

Optionally, reference signals separately received by the receiver 803 on the at least two transmission subbands have a same configuration.

Optionally, the receiver 803 is further configured to: after the user equipment accesses the at least two transmission subbands, simultaneously receive, on a common transmission subband, at least one set of signals sent by using at least one different analog beam, where each set of signals includes at least one signal of a reference signal, a synchronization signal, a system information block SIB, and a common search space CSS signal of a control channel, and the common transmission subband is one of the at least two transmission subbands.

Optionally, the receiver 803 is further configured to receive instruction information on the common transmission subband, where the instruction information is used to instruct to use at least one other transmission subband in the S transmission subbands as an additional transmission subband that is used to transmit the CSS signal.

Optionally, each of the at least two transmission subbands is associated with one piece of precoding, the precoding associated with each transmission subband is precoding in a first precoding group at a first moment, the precoding associated with each transmission subband is precoding in a second precoding group at a second moment, and precoding in the first precoding group is not identical to precoding in the second precoding group.

Various variations and specific instances in the data transmission method in the foregoing embodiment shown in FIG. 2 are also applicable to the user equipment in this embodiment. With the foregoing detailed descriptions of the data transmission method, a person skilled in the art can clearly understand an implementation of the user equipment in this embodiment. Therefore, for conciseness of the specification, details are not described herein again.

Based on a same invention concept, an embodiment of the present invention further provides a network side device to implement the method shown in FIG. 2. As shown in FIG. 9, the network side device includes a processor 901, a transmitter 902, a receiver 903, and a memory 904. The processor 901 may be specifically a central processing unit or an application-specific integrated circuit (English: Application Specific Integrated Circuit, ASIC for short), or may be one or more integrated circuits used to control program execution, or may be a hardware circuit developed by using a field programmable gate array (English: Field Programmable Gate Array, FPGA for short). There may be one or more memories 904. The memory 904 may include a read-only memory (English: Read Only Memory, ROM for short), a random access memory (English: Random Access Memory, RAM for short), and a magnetic disk storage. These memories, the receiver 903, and the transmitter 902 are connected to the processing circuit 901 by using a bus. The receiver 903 and the transmitter 902 are configured to communicate with an external device by using a network, and specifically, may communicate with the external device by using a network such as the Ethernet, a radio access network, or a wireless local area network. The receiver 903 and the transmitter 902 may be two physically independent elements, or may be a physically same element.

Specifically, the processor 901 is configured to obtain first downlink control information and second downlink control information. The transmitter 902 is configured to: at a first moment, send the first downlink control information on a physical downlink control channel PDCCH by using first precoding; and at the first moment, send the second downlink control information on an enhanced physical downlink control channel EPDCCH by using second precoding, where the first precoding is different from the second precoding.

Various variations and specific instances in the downlink control information transmission method in the foregoing embodiment shown in FIG. 3 are also applicable to the network side device in this embodiment. With the foregoing detailed descriptions of the downlink control information transmission method, a person skilled in the art can clearly understand an implementation of the network side device in this embodiment. Therefore, for conciseness of the specification, details are not described herein again.

The one or more technical solutions provided in the embodiments of this application have at least the following technical effects or advantages:

In the embodiments of the present invention, an entire system bandwidth is divided into multiple transmission subbands that do not overlap each other. UE accesses at least two transmission subbands. When the UE and a network device transmit a signal, the signal can be simultaneously transmitted on the at least two transmission subbands. Therefore, according to the method in the embodiments of the present invention, UE connection reliability and data transmission reliability can be enhanced. When the method is applied to a high frequency band that requires relatively high data transmission reliability, a bandwidth of the entire high frequency band may be divided into multiple low-frequency transmission subbands that do not overlap each other, and the UE simultaneously accesses at least two transmission subbands. That is, according to the method in the embodiments of the present invention, diversity transmission of multiple connections is kept on the at least two transmission subbands, so that when high frequency coverage is limited, the UE connection reliability and the data transmission reliability can be improved, and a probability of a connection failure caused by movement of a user and a channel change in high frequency is reduced. Further, practicability of applying the high frequency band to cellular communication is improved.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

What is claimed is:

1. A data transmission method, comprising:
receiving, by a user equipment (UE), a respective reference signal on each of S transmission subbands, wherein the S transmission subbands are non-overlapped with each other, and S is an integer greater than or equal to 2;
performing, by the UE, channel quality measurements on the respective reference signals on M transmission subbands in the S transmission subbands;
selecting, by the UE, at least two transmission subbands from the M transmission subbands according to the channel quality measurements;
accessing, by the UE, the at least two transmission subbands; and
sending, by the UE, a data channel signal on the at least two transmission subbands.

2. The method according to claim 1, wherein before the receiving, by the UE, the respective reference signal on each of the S transmission subbands, the method further comprises one of:
determining the S transmission subbands according to predefined information, wherein the predefined information is cell-specific or user-specific; or
receiving configuration information of the S transmission subbands, and determining the S transmission subbands based on the configuration information, wherein the configuration information is cell-specific or user-specific.

3. The method according to claim 1, wherein after the accessing, by the UE, the at least two transmission subbands, the method further comprises:
receiving, by the UE, at least one of a second reference signal, a synchronization signal, a broadcast channel (BCH) signal, or a control channel signal on each of the at least two transmission subbands.

4. The method according to claim 3, wherein the second reference signals received by the UE on the at least two transmission subbands have a same configuration.

5. The method according to claim 1, wherein after the accessing, by the UE, the at least two transmission subbands, the method further comprises:
receiving, by the UE on a common transmission subband, at least one set of signals sent by using at least one different analog beam, wherein each set of signals comprises at least one signal of a third reference signal, a synchronization signal, a system information block (SIB), and a common search space (CS S) signal of a control channel, and the common transmission subband is one of the at least two transmission subbands.

6. The method according to claim 5, wherein after the accessing, by the UE, the at least two transmission subbands, the method further comprises:
receiving, by the UE, instruction information on the common transmission subband, wherein the instruction information is used to instruct to use at least one other transmission subband in the S transmission subbands as an additional transmission subband that is used to transmit the CSS signal.

7. The method according to claim 1, wherein each of the at least two transmission subbands is associated with one piece of precoding, the precoding associated with each transmission subband is precoding in a first precoding group at a first moment, the precoding associated with each transmission subband is precoding in a second precoding group at a second moment, and the precoding in the first precoding group is different than the precoding in the second precoding group.

8. A network side device, comprising:
at least one processor, the at least one processor configured to determine S transmission subbands for a user equipment (UE), wherein the S transmission subbands are non-overlapped with each other, and S is an integer greater than or equal to 2; and
a transmitter coupled to the at least one processor, the transmitter configured to:
send a respective reference signal on each of the S transmission subbands, wherein the UE selects at least two transmission subbands from M transmission subbands in the S transmission subbands based on channel quality measurements of the respective reference signals on the M transmission subbands, and accesses the at least two transmission subbands, wherein M is an integer greater than or equal to 2 and less than or equal to S; and
send a data channel signal to the UE on the at least two transmission subbands.

9. The network side device according to claim 8, wherein the at least one processor is configured to determine the S transmission subbands for the UE according to predefined information, wherein the predefined information is cell-specific or user-specific.

10. The network side device according to claim 8, wherein the transmitter is further configured to send at least one of a second reference signal, a synchronization signal, a broadcast channel (BCH) signal, or a control channel signal on each of the at least two transmission subbands after sending the respective reference signals on the S transmission subbands.

11. The network side device according to claim 8, wherein the at least one processor is further configured to determine a transmission subband in the at least two transmission subbands as a common transmission subband after the transmitter sends the respective reference signals on the S transmission subbands; and
the transmitter is further configured to send at least one set of signals on the common transmission subband by using at least one different analog beam, wherein each set of signals comprises at least one signal of a third reference signal, a synchronization signal, a system information block (SIB), and a common search space (CSS) signal of a control channel.

12. The network side device according to claim 11, wherein the transmitter is further configured to send instruction information on the common transmission subband, wherein the instruction information is used to instruct to use at least one other transmission subband in the S transmission subbands as an additional transmission subband that is used to transmit the CSS signal.

13. The network side device according to claim 8, wherein each of the at least two transmission subbands is associated with one piece of precoding, the precoding associated with each transmission subband is precoding in a first precoding group at a first moment, the precoding associated with each transmission subband is precoding in a second precoding group at a second moment, and the precoding in the first precoding group is different than the precoding in the second precoding group.

14. A user equipment, comprising:
at least one processor;
a receiver coupled to the at least one processor, the receiver configured to receive a respective reference signal on each of S transmission subbands, wherein the S transmission subbands are non-overlapped with each other, and S is an integer greater than or equal to 2;
the at least one processor configured to:
perform channel quality measurements on the respective reference signals on M transmission subbands in the S transmission subbands;
select at least two transmission subbands from the M transmission subbands according to the channel quality measurements; and
access the at least two transmission subbands; and
a transmitter coupled to the at least one processor, the transmitter configured to send a data channel signal on the at least two transmission subbands.

15. The user equipment according to claim 14, wherein at least one of the following:
the at least one processor is further configured to determine the S transmission subbands according to predefined information, wherein the predefined information is cell-specific or user-specific; or
the receiver is further configured to receive configuration information of the S transmission subbands, and the at least one processor is further configured to determine the S transmission subbands based on the configuration information, wherein the configuration information is cell-specific or user-specific.

16. The user equipment according to claim 15, wherein the receiver is further configured to receive at least one of a second reference signal, a synchronization signal, a broadcast channel (BCH) signal, or a control channel signal on each of the at least two transmission subbands after the user equipment accesses the at least two transmission subbands.

17. The user equipment according to claim 16, wherein the second reference signals received by the receiver on the at least two transmission subbands have a same configuration.

18. The user equipment according to claim 14, wherein the receiver is further configured to: after the user equipment accesses the at least two transmission subbands, receive, on a common transmission subband, at least one set of signals sent by using at least one different analog beam, wherein each set of signals comprises at least one signal of a third reference signal, a synchronization signal, a system information block (SIB), and a common search space (CSS) signal of a control channel, and the common transmission subband is one of the at least two transmission subbands.

19. The user equipment according to claim 18, wherein the receiver is further configured to receive instruction information on the common transmission subband, wherein the instruction information is used to instruct to use at least one other transmission subband in the S transmission subbands as an additional transmission subband that is used to transmit the CSS signal.

20. The user equipment according to claim 14, wherein each of the at least two transmission subbands is associated with one piece of precoding, the precoding associated with each transmission subband is precoding in a first precoding group at a first moment, the precoding associated with each transmission subband is precoding in a second precoding group at a second moment, and the precoding in the first precoding group is different than the precoding in the second precoding group.
